(19) United States
(12) Patent Application Publication
(10) Pub. No.: US 2021/0332452 A1
(43) Pub. Date: Oct. 28, 2021

(54) SYSTEMS AND METHODS FOR PROCESSING METALLIC ARTICLES WITH A RETORT FURNACE

(71) Applicant: Consolidated Engineering Company, Inc., Kennesaw, GA (US)

(72) Inventors: Shanker Subramaniam, Marietta, GA (US); Piotr Mikhailovich Khramov, Powder Springs, GA (US)

(21) Appl. No.: 17/236,137

(22) Filed: Apr. 21, 2021

Related U.S. Application Data
(60) Provisional application No. 63/014,922, filed on Apr. 24, 2020.

(51) Int. Cl. C21D 9/00; C23C 8/22; C21D 11/00; F27B 9/24; F27B 9/40; F27D 3/00

(52) U.S. Cl. CPC C21D 9/0031; C23C 8/22; C21D 11/00; F27B 2009/382; F27B 9/40; F27D 3/0024; F27B 2009/2484; F27B 9/24

(57) ABSTRACT

Systems and methods for annealing, carburizing and/or other treatments of metallic articles include a retort furnace having a retort. The metallic articles are fed into a chamber of the retort through an inlet section of the retort and are subjected to heating. The retort is oscillated and/or rotated back and forth as the metallic articles are heated, causing the metallic articles to be moved along the chamber of the retort to a discharge.

### REFERENCE TO RELATED APPLICATION

The present Patent application claims the benefit of pending U.S. Provisional Patent Application No. 63/014,922, filed on Apr. 24, 2020.

### INCORPORATION BY REFERENCE

The disclosures made in U.S. Provisional Patent Application No. 63/014,922, filed on Apr. 24, 2020 are specifically incorporated by reference herein as if set forth in their entireties.

### TECHNICAL FIELD

The present disclosure is generally related to systems and methods for processing of metallic materials, and in particular, systems and methods for heating metallic articles for annealing, carburizing, etc., of the metallic articles. Other aspects also are described.

### BACKGROUND

Existing retort furnaces generally have inefficient drive systems that require large amounts of torque/power and loading systems which can experience considerable amounts of heat loss during operation. For example, exiting retort furnaces can have side loading mechanisms for loading articles into a retort of the retort furnace and direct drive systems that are directly connected to the retort for driving rotation of the retort. In addition, existing retort furnaces generally rely on substantially continuous full rotation of the retort leading to inefficient processing like annealing or carburizing of the article. Accordingly, it can be seen that a need exists to address the foregoing and other related and unrelated problems or issues in the art.

### SUMMARY

Briefly described, the present disclosure is directed to a system for processing metallic articles. The metallic articles can include coin blanks, such as blanks for nickels, dimes, quarters, 50 cent pieces, dollars, etc., or other small, metallic articles including, but not limited to, screws, nuts, bolts, washers, etc. The system includes a retort furnace that facilitates annealing, carburizing, etc. of metallic articles. The retort furnace includes a furnace housing or heated box with a furnace chamber or compartment at least partially defined by portions or sections of the furnace housing. The furnace chamber of the retort furnace contains a gas, such as nitrogen, hydrogen, or other gases, or combinations thereof. The retort furnace further has heaters that heat or maintain the furnace chamber of the retort furnace to/at a prescribed temperature.

The system further includes a retort that is rotatably mounted to the furnace housing and that extends within the furnace chamber. The retort is configured to receive metallic articles for annealing, carburizing, or other suitable heat processing of the metallic articles. The retort includes a retort body having a substantially elongated, cylindrical shape or configuration. In one embodiment, the retort body includes a cylindrical, circumferential sidewall at least partially defining a retort chamber or cavity of the retort body into which the metallic articles are received. The retort body further includes a charge inlet and a discharge outlet, each defined in the circumferential sidewall and in communication with the chamber of the retort body for charging and discharging of the metallic articles into/from the chamber of the retort body. In one embodiment, the inlet is formed at or substantially adjacent an upstream or charge end of the retort body, and the outlet is formed at or substantially adjacent a downstream or discharge end of the retort body.

The retort also includes internal helical flights or helical members positioned within the chamber of the retort body and extending along the retort body for moving metallic articles from the upstream end to the downstream end of the retort body. The helical flights can include a flight body, which can include a unitary structure or can be made up of a plurality of interconnected parts or sections, with a helical shape or construction, e.g., similar in shape to a helical screw or auger, that is fixed to the retort body. In this regard, the helical flights are configured to engage and move metallic articles received within the inlet at the upstream end of the retort body towards the outlet at the downstream end of the retort body, with oscillation or rotation of the retort, for carbonizing or annealing of the metallic articles. Other configurations of flights, including non-helical flights, also can be used.

In addition, the system includes a support system movably mounting the retort to the retort furnace. The support system can include a pair of opposing shafts or hollow tubes connected to the retort body. The shafts can include a first, upstream shaft that is connected to and extends from the upstream end of the retort body, and a second, downstream shaft that is connected to and extends from the downstream end of the retort body. The support system further can include bearing assemblies or other suitable mounting assemblies that movably support the shafts. The bearing assemblies can include bearings connected to the shafts, such that the shafts are rotatable with respect to the furnace housing the bearing assembles further can include and beams or supports connecting the bearings to the furnace housing. The shafts can be connected to the retort body at or along a first end portion or area of each shaft and can be connected to the bearings of the bearing assembles at a second, opposing end portion or area of the shafts. The shafts and bearings can be cooled, e.g., by one or more water or air gas cooling systems. In addition, in some embodiments, a gas system can be provided in communication with the shafts, the gas system will supply one or more gases, such as hydrogen, nitrogen, other gases, or combinations thereof, can be introduced into the retort through the shafts at one or both ends of the retort, e.g., via openings, passages, injectors, etc.

The support system also can include a support or mounting assembly connecting the shafts to the upstream and downstream ends of the retort body. In one embodiment, the support assembly can include one or more conical or frusto-conical structures connecting the shafts to the upstream and downstream ends of the retort body. The conical structures can be configured to help to reduce stresses or forces, such as, bending or torsion, experienced along the shafts, e.g., to reduce, inhibit, or prevent wear, damage, breakage, etc., of the shafts.

The system further includes one or more retort drive systems or mechanisms operatively connected to one or both of the opposing shafts to drive movement of the retort. The system also can include a control system with a controller in communication with drive system(s) and operable to transmit one or more control signals to the drive system(s) to control driving, e.g., activating, stopping reversing, etc., of the retort. In particular, the control system can control the drive system to rotate and/or oscillate the retort back and forth during heating of the metallic articles. In one embodiment, the drive system can oscillate the retort up to about 360° back and forth. In addition, or in the alternative, the drive system can oscillate the retort up to about 90° or up to about 180° back and forth. The control system further can be configured to rotate the retort body multiple revolutions at different and variable speeds without departing from the scope of the present disclosure.

The system also includes a discharge assembly that is in communication with the discharge outlet of retort body, and a quenching tank or container that receives metallic articles discharged from the discharge outlet. In one embodiment, the discharge assembly includes a discharge chute that extends from the furnace housing into the quenching tank. The discharge chute can be substantially sealed with the retort body to help to reduce dissipation of heat from the retort furnace.

In addition, the system includes an inlet assembly in communication with the charge inlet of the retort body for loading of metallic articles into the retort body. In one embodiment, the inlet assembly includes a fixed inlet or charging chute positioned along a top portion or section of the furnace body. The fixed inlet chute further can be configured to vertically discharge metallic articles into the chamber of the retort body. The fixed inlet chute can be substantially sealed against the retort body to help to reduce dissipation of heat from the retort furnace.

In one embodiment, the charge inlet includes an inlet slot or elongated aperture defined in the circumferential sidewall of the retort body. This inlet slot can be configured to be periodically brought into communication with the fixed inlet chute during oscillation or rotation of the retort for charging of metallic articles into the chamber of the retort body. In addition, the discharge outlet can include a discharge slot or elongated aperture defined in the circumferential sidewall of the retort body. This discharge slot also can be configured to be periodically brought into communication with the discharge chute extending from the furnace housing during oscillation or rotation of the retort for discharging metallic articles from the chamber of the retort body into the container. Periodic communication between the inlet slot and the fixed inlet chute and between the discharge slot and discharge chute can help to provide a substantially constant flow of metallic articles through the chamber of the retort body.

Furthermore, the retort can include an inlet section or area at or substantially adjacent the upstream end of the retort body. The inlet section or area can be configured to direct or funnel metallic articles received into the retort body through the charge inlet to an interior surface of the circumferential sidewall of the retort body in a cascading manner, such that metallic articles do not free fall from the charge inlet in the retort body to the opposing side of the retort body. In this regard, the inlet section or area can help to reduce, inhibit, or prevent damage to, e.g., scoring, nicking, scratching, etc., metallic articles received into the chamber of the retort body.

In one embodiment, the inlet section can include one or more support bars or engagement members positioned within the chamber of the retort body to engage and direct metallic articles received in the retort body from the inlet slot. In particular, the support bar(s) can be connect to and oscillate or rotate with the retort to cascade metallic articles to interior surface of the circumferential sidewall of the retort as the retort moves to prevent dropping of metallic articles directly into the retort body, i.e., dropping directly from the inlet slot to the opposing interior surface of the circumferential sidewall. The support bar(s) can be in at least partial alignment with the inlet slot to engage and direct metallic articles received into the chamber of the retort body through the inlet slot. The support bar(s) further can be sloped or angled in relation to the inlet slot to help to direct metallic articles to the interior surface of the circumferential sidewall, without jamming or other substantial disruptions of the flow of metallic articles through the inlet slot.

In alternative embodiments, the inlet section or area of the retort can include a plurality of support bars or engagement members configured to engage and direct metallic articles received into the retort body through the charge inlet in a cascading manner to help to reduce, prevent, or inhibit damage to the metallic articles as the metallic articles are received into the retort body. In this regard, the plurality of engagement members can define a path or passage through which the metallic articles move/are directed as the retort body is oscillated or rotated.

The system further can be configured to run a cleaning cycle for removal of lodged or stuck metallic articles or debris from the chamber of the retort body. During the cleaning cycle, cleaning materials, including but not limited to hard spherical cleaning objects, can be received in the retort body, e.g., through the inlet slot, and the retort can be rotated or oscillated for a predetermined time interval. The cleaning materials can be moved and directed by the helical flights from the upstream end of the retort body to the downstream end of the retort body and can engage lodged metallic articles or debris to clean the chamber of the retort body. The cleaning materials can be discharged from the discharge slot of the retort body.

Additionally, the present disclosure provides a method for processing metallic articles. According to the method, metallic articles can be loaded or otherwise received within an inlet chute of a retort furnace. One or more heaters can be activated (e.g., via control system) to heat a furnace chamber of the retort furnace to a prescribed temperature, e.g., between about 1000° F. and about 2000° F., such as 1600° F., and up to 2100° F. or more, for carburizing or annealing of metallic articles. A retort of the retort furnace can be oscillated back and forth, e.g., in opposite first and second directions of up to about 90 degrees, up to about 180 degrees, up to about 360 degrees, etc. in either or both directions, and each time the inlet chute is at least partially aligned with a charge inlet defined through a circumferential surface of the retort, with oscillation of the retort, metallic articles can be received from the inlet chute into a chamber of the retort. The metallic articles can be received into an inlet section of the retort including one or more support bars that engage and direct metallic articles in the chamber of the retort, e.g., in a cascading manner to an interior surface of the retort.

Furthermore, metallic articles received within the retort can be engaged by an internal helical flights positioned in the chamber of the retort (e.g., upon exiting of the inlet section) and moved toward a discharge end of the retort. In particular, due to oscillation of the retort, metallic articles can be engaged by various sections of the internal helical flights and moved along the retort to the discharge end of the retort. The oscillating motion and/or back and forth rotation of the retort will be controlled to control a dwell time of the metallic articles within the retort chamber to facilitate a substantially uniform heating thereof. Thus, the retort can have a reduced or more compact size and/or, configuration while enabling a desired treatment (e.g. annealing carburizing or other heat treatment).

When metallic articles reach the discharge end of the retort, metallic articles can be discharged from the retort through a discharge outlet defined through a circumferential surface of the retort. For example, metallic articles can be discharged from the discharge outlet each time the discharge outlet is at least partially aligned with a discharge chute, due to oscillation or rotation of the retort.

The metallic articles can be directed through the discharge chute to one or more quenching tanks. After quenching of metallic articles, metallic articles can be moved from the quenching tank to one or more additional processing stations for additional or post processing of annealed, carburized, etc. metallic articles, e.g., for cutting, stamping, etc. of metallic articles.

The method further can include cleaning cycle for the retort. For example, one or more cleaning materials, e.g., including spherical objects, can be added to the retort chamber and the retort can be oscillated or rotated, such that the cleaning materials move through the retort to dislodge any metallic articles or debris lodged or stuck in the chamber of the retort.

These and other advantages and aspects of the embodiments of the disclosure will become apparent and more readily appreciated from the following detailed description of the embodiments and the claims, taken in conjunction with the accompanying drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the embodiments of the present disclosure, are incorporated in and constitute a part of this specification, illustrate embodiments of the invention, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced.

FIG. 1 shows an elevation view of a system for processing of metallic articles according to principles of the present disclosure.

FIGS. 2A and 2B provide a cross-sectional and schematic views of a retort furnace of the system of FIG. 1.

FIGS. 3A, 3B, 3C, and 3D show perspective, schematic, and cross-sectional views of a retort according to one example embodiment of the present disclosure.

FIG. 4 shows a partial perspective view of a retort according to another embodiment of the present disclosure.

FIGS. 5A and 5B show partially cutaway views of an inlet section of a retort according to one embodiment of the present disclosure.

FIGS. 6A and 6B show schematic view of an inlet section of a retort according to additional embodiments of the present disclosure.

### DETAILED DESCRIPTION

The following description is provided as an enabling teaching of embodiments of this disclosure. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the embodiments of the present disclosure and not in limitation thereof.

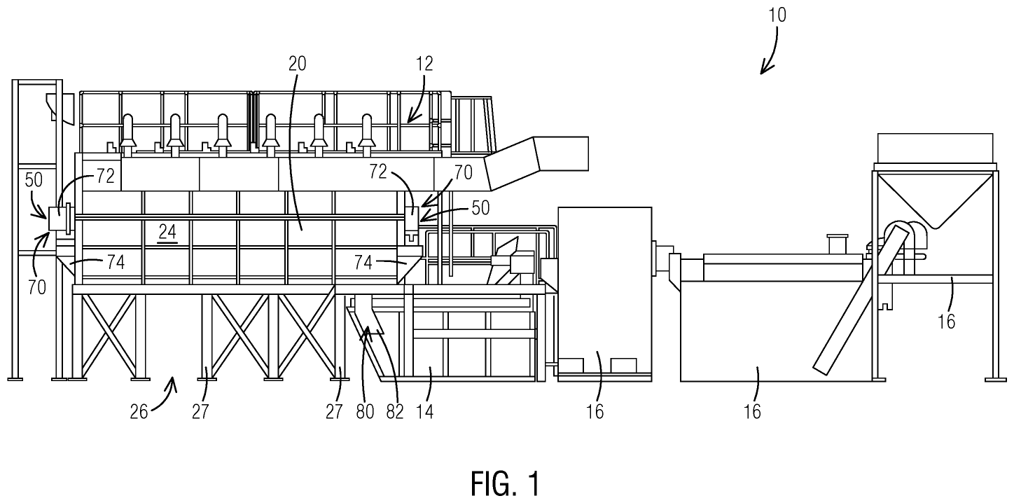

FIGS. 1, 2A-2B, 3A-3D, 4, 5A-5B, and 6A-6B illustrate a system 10 for processing metallic articles, including, but not limited to, coin blanks, such as blanks for nickels, dimes, quarters, 50 cent pieces, dollars, etc., or other small, metallic articles, such as screws, nuts, bolts, washers, etc. The system 10 also can process a variety of other metallic articles as will be understood by those having skill in the art, without departing from the scope of the present disclosure.

As shown in FIG. 1, the system 10 includes a retort furnace 12 that facilitates annealing, carburizing, and other heat treatments of metallic articles. The system 10 also includes a quenching tank 14 in communication with the retort furnace 12. The quenching tank 14 contains a liquid or gas, such as water, oil, air, etc., to rapidly cool metallic articles discharged from the retort furnace 12.

In addition, the system 10 can include one or more additional or post processing stations 16 for additional or subsequent processing of annealed, carburized, etc. metallic articles. The post processing stations 16 can include stamping stations, cutting stations, etc., or other suitable additional or post processing stations for metallic articles as will be understood by those skilled in the art.

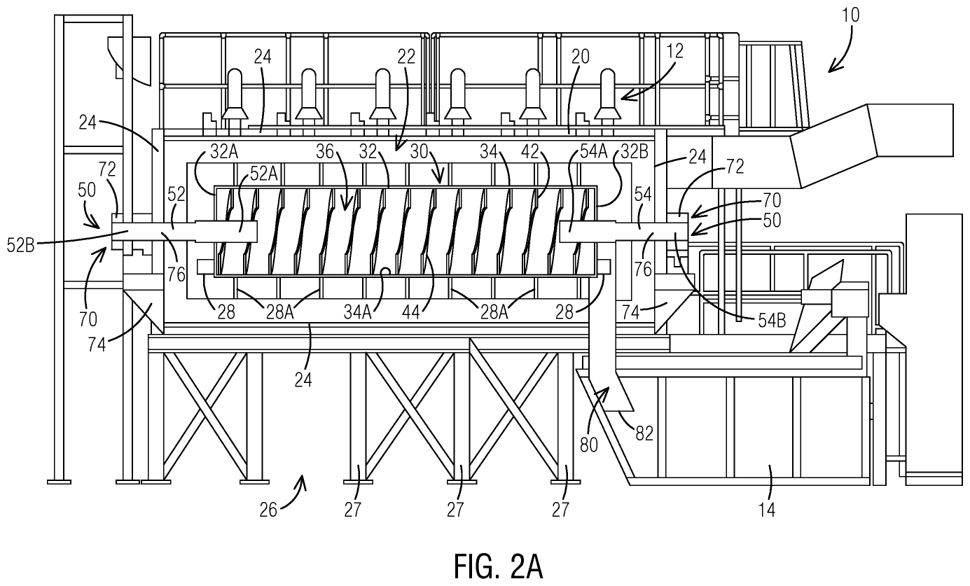

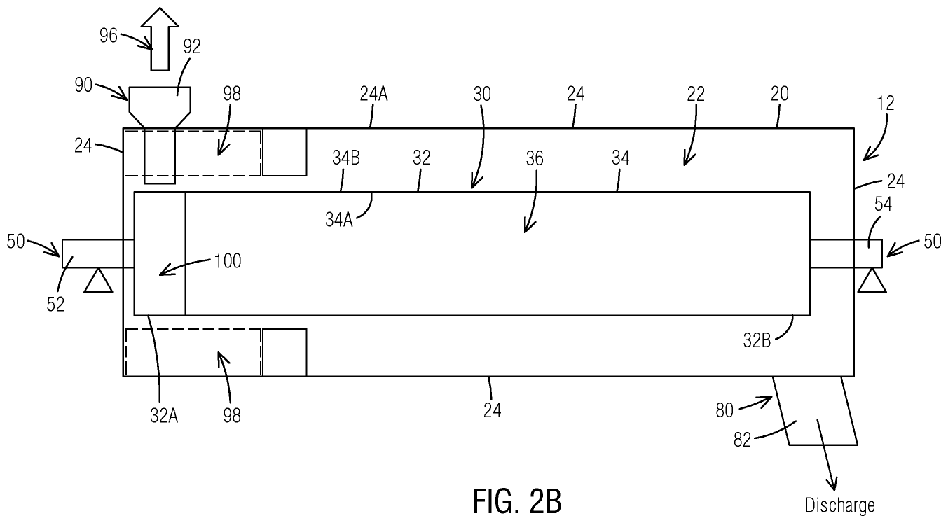

FIGS. 1 and 2A-2B show that the retort furnace 12 includes a furnace housing, casing, or heated box 20 with a furnace chamber or compartment 22 at least partially defined by portions or sections 24 of the furnace housing 20. The chamber 22 of the retort furnace 12 will be supplied with and contains a gas, such as nitrogen, hydrogen, or a combination of gases. The furnace housing 22 further can be supported by a platform 26 that includes a plurality of supports 27 (FIGS. 1 and 2A-2B). The retort furnace 12 further includes heaters or heating elements 28 in communication with the furnace housing 20 that heat or maintain the chamber 22 of the retort furnace to/at a prescribed temperature. In one embodiment, the heaters include radiant heating tubes 28A positioned within the furnace chamber 22. According to embodiments of the present disclosure, the heaters can heat or maintain the furnace chamber at temperatures in a range of between about 1000° F. and about 2000° F., and in embodiments, in ranges such as about 500° F. to about 2000° F., to about 1600° F., and/or to about 2100° F. or more.

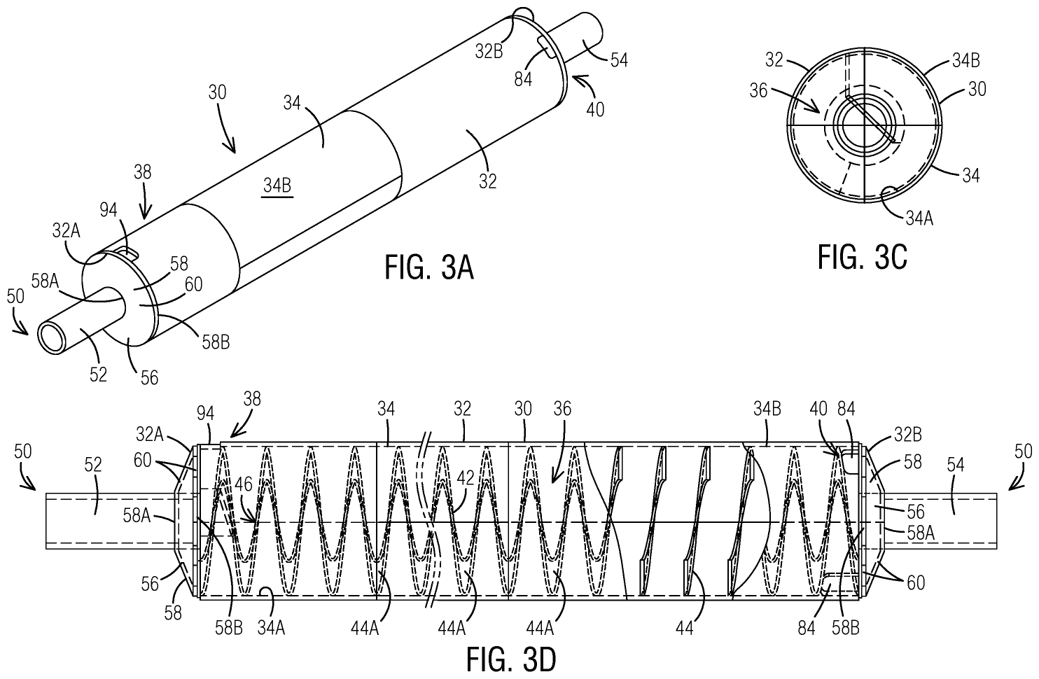

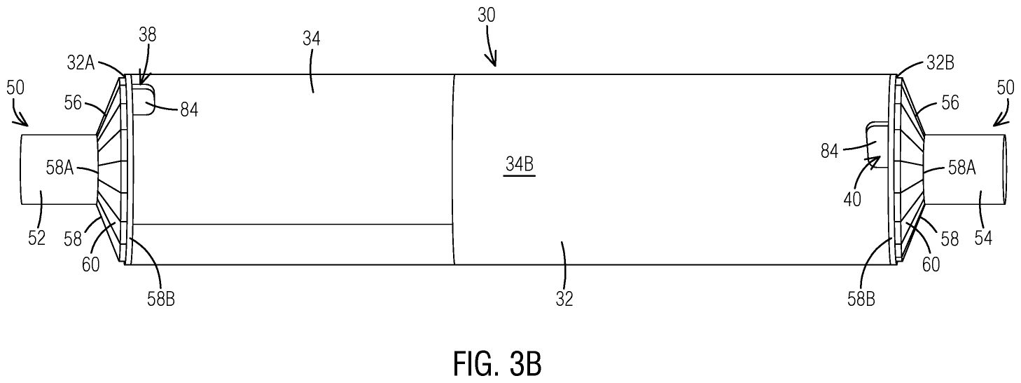

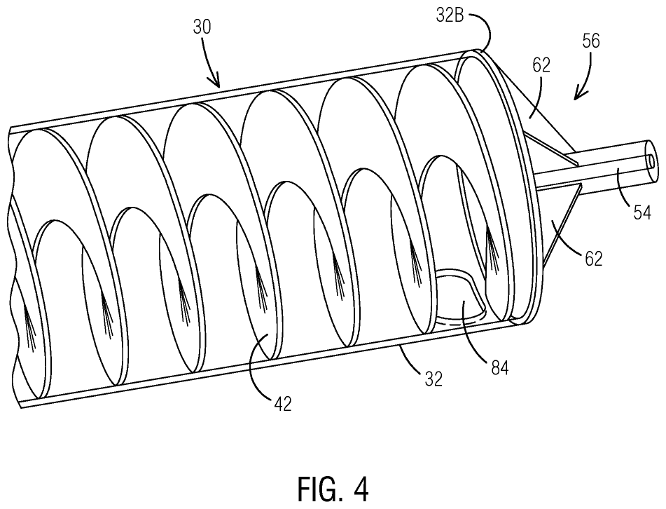

As FIGS. 2A-2B and 3A-3D further indicate, the retort furnace 12 includes a retort 30 that is rotatably mounted to the furnace housing 20 and that extends within and at least partially along the furnace chamber 22. The retort 30 is configured to receive metallic articles and to oscillate or rotate to facilitate annealing, carburizing, or other suitable heat processing of received metallic articles. The retort 30 includes a retort body 32 generally having a substantially elongated, cylindrical shape or configuration. The retort body 32 further has a cylindrical, circumferential sidewall 34 at least partially defining a retort chamber or cavity 36 of the retort body 32 into which metallic articles are received. The circumferential sidewall 34 includes opposing inner 34A and outer 34B surfaces. The retort body 32 generally can be formed or cast from metallic materials, such as alloys including, but not limited to, HT, HU, HW, or other heat resistant alloys, or combinations thereof, though other composite or synthetic materials are possible without departing form the scope of the present disclosure. Furthermore, in some embodiments, the retort body 32 can have a length ranging from about 100 inches to about 500 inches, and an inner diameter ranging from about 18 inches to about 60 inches.

As additionally shown in FIGS. 3A, 3B, and 3D, the retort body 32 includes a charge inlet 38 defined through the circumferential sidewall 34, and which is in communication with the retort chamber 36 of the retort body 32 for charging of metallic articles into the retort body 32. And, the retort body 32 additionally includes a discharge outlet 40 defined in the circumferential sidewall 34 and in communication with the retort chamber 36 of the retort body 32 for discharging of the metallic articles from the retort body 32. In one embodiment, the discharge 40 outlet is in communication with the quenching tank 12. In one embodiment, the charge inlet 38 is formed at or substantially adjacent an upstream, inlet or charge end 32A of the retort body 32, and the discharge outlet 40 is formed at or substantially adjacent a downstream, outlet or discharge end 32B of the retort body 32 (FIGS. 3A, 3B, and 3D).

FIGS. 2A and 3D show that the retort 30 also includes an array of internal helical flights or helical members 42 positioned within the retort chamber 36 of the retort body 32. As FIGS. 2A and 3D indicate, the helical flights 42 extend along the retort body 32 and are fixed to and movable with the retort body 32 to facilitate directing and moving of metallic articles from the upstream end 32A to the downstream end 32B of the retort body 32. In particular, as the retort body 32 is oscillated or rotated, the helical flights 42 engage and move metallic articles received within and/or through the charge inlet 38 at the upstream end 32A of the retort body 32 towards the discharge outlet 40 at the downstream end 32B of the retort body 32 to facilitate carburizing or annealing of the metallic articles within the retort furnace 12.

According to embodiments of the present disclosure, the helical flights 42 each include a flight body 44 with a helical shape, similar to a helical screw or auger, that is fixed to the circumferential sidewall 34 of the retort body 32. Other configurations also can be used. In the illustrated embodiment, as generally shown in FIG. 3D, each flight body 44 has a generally rectangular cross-section, though other constructions or shapes, e.g., square, arcuate, etc. are possible without departing from the scope of the present disclosure. Each flight body 44 can include a substantially unitary structure or can be formed from a plurality of interconnected components. Each flight body 44 can be formed from one or more metallic materials, though other synthetic, composite, etc. materials can be used without departing from the scope of the present disclosure. Each flight body 44 further can be connected to the interior surface 34A of the retort body 32, e.g., by welding, fusing, etc. In this regard, each flight body 44 is configured to engage and direct metallic articles along the retort body 32, with movement of the retort 30.

As the retort 30 is oscillated or rotated, a metallic article can be engaged by various sections or areas 44A of the flight body 44 to direct and move the metallic article toward the discharge 40 of the retort body 32. In some embodiments, a metallic article may travel from the upstream end 32A to the downstream end 32B of the retort body 32 in a range between about 30 minutes to about 60 minutes or longer or less depending on the process required and size/weight of the article. The flight body 44 further can define openings or passages 46 through the center of each of the helical flights 42, and in some instances, metallic articles can spill or topple over the flight body 44 between different sections or areas 44A of the flight body 44 toward the discharge 40, though the quantity of metallic articles loaded into the retort 30 can be selected to reduce, inhibit, or prevent spill-over of metallic articles. In some embodiments, the flight body 44 or each helical flight has a thickness in a range of about 0.5 inches to about 0.75 inches, such as 0.6 inches; a width of in a range of about 8 inches to about 12 inches, such as about 9 inches; and a pitch length in a range of about 10 inches to about 14 inches, such as about 12 inches.

FIGS. 2A and 2B further show a support system 50 that rotatably connects the retort 30 to the retort furnace 12. As FIGS. 2A and 2B indicate, the support system 50 can include a pair of opposing shafts, trunnions, or hollow tubes 52, 54 connected to opposing ends 32A/32B of the retort body 32. In particular, the shafts 52 can include a first, upstream shaft 52 that is connected to and extends from the upstream end 32A of the retort body 32, and a second, downstream shaft 54 that is connected to and extends from the downstream end 32B of the retort body 32. The shafts 52 and 54 can be cast or formed from one or more metallic materials, though synthetic, composite, or other materials can be used without departing from the scope of the present disclosure. The shafts 52, 54 also can extend into the retort body 32 and can engage or be connected to the flight body 44, e.g., engage or connect to the first two sections of the flight body 44 at the upstream 32A and downstream ends 32B of the retort body 32. For example, the shafts 52, 54 can be welded, fused, etc. to one or more portions of the flight body 44 along a first end portion 52A, 54A of the shafts 52 and 54 (FIG. 2A).

In some embodiments, the shafts 52, 54 can have a diameter in a range of about 12 inches to about 24 inches, such as about 16 inches to 20 inches; can extend from the retort body 32 a distance in a range from about 28 inches to about 45 inches, such as about 30 inches to about 42 inches; and can extend into the retort body 32 a distance in a range from about 12 inches to about 18 inches. The reduced diameter of the shafts 52 and 54 in comparison to the retort body 32 can help to reduce power and/or torque requirements, as well increase efficiency, for driving of the retort 30 in comparison to traditional retort furnaces that have direct drive mechanism, (e.g., that is directly connected to the body of the retort). The reduced size of the shafts also can help to reduce heat transfer or heat loss from the retort furnace 12, and also reduces the temperature, as well as thermal expansion, of the shafts (and the retort drive system) further increasing the efficiency of the retort furnace 12 in comparison to traditional retort furnaces (e.g., which may have support/drive systems requiring direct driving of the retort). The configuration of the shafts also can allow for improved sealing of the furnace (e.g., reducing circumferential sealing requirements), and less leakage of furnace atmosphere in comparison to traditional retort furnaces.

In some embodiments, the system 10 further can include a gas or atmospheric system configured to supply one or more gases, such as hydrogen, nitrogen, other gases, or combinations thereof, to the chamber 36 of the retort body 32. The gas system can be configured to provide one or more gases to the chamber of the retort body 32 through or along one or both of the shafts 52 and/or 54. In this regard, the shafts 52 and/or 54 can include passages, openings, etc., defined along, in, or through the shafts 52/54 for providing one or more gases to the chamber 26 of the retort body 32. The gas system further can include tubing, hoses, pumps, injectors, etc., e.g., in communication with the passages, openings, etc., of the shafts, and configured to facilitate delivery of the one or more gases to the chamber 26 of the retort body 32.

As also illustrated in FIGS. 3A, 3B, 3D and 4, the support system 50 can include a support or mounting assembly 56 connecting the shafts 52 and 54 to the retort body 32. In particular, the support assembly 56 can include one or more conical structures 58 connecting the shafts 52 and 54 to the upstream 32A and downstream 32B ends of the retort body 32. In one embodiment, a conical structure 58 can be made up of a plurality of bodies, castings, or members 60, e.g., each having a flat, plate-like constructions, defining a substantially hollow conical structure, though in alternative constructions the structure can include solid or at least partially solid portions or sections. The bodies 60 can be connected together, e.g., via welding, fusing, etc., or can be integrally formed with one another. In some embodiments, the bodies 60 can have a thickness in the range of about 0.5 inches to about 2 inches, such as about 1 inch. The structure 58 further can have a first end 58A that is connected to the shafts 52 and 54 at a position that is spaced away from the retort body 32 along the shafts 52 and 54 (e.g., spaced away at a distance in a range of about 4 inches to about 10 inches, such as about 6 inches in one embodiment, from the retort body 32 along the shaft 52/54) and a second, opposing end 58B that is connected to the retort body 32, e.g., along the upstream 32A and downstream 32B ends of the retort body 32. The bodies 60 can be welded, fused, etc. together and to the shafts 52 and 54 and/or the retort body 32, though the one or more bodies 60 can be integrally formed with each other, the shafts 52 and 54, and/or the retort body 32, without departing from the scope of the present disclosure. The bodies 60 can be formed from one or more metallic materials, though other synthetic, composite, etc. materials can be used without departing from the scope of the present disclosure. The structure 58 can reinforce the shafts 52 and 54 and help to reduce stresses or forces, such as, bending or torsion, experienced along the shafts 52 and 54, e.g., to reduce, inhibit, or prevent wear, damage, breakage, etc., of the shafts. The structure 58 also can reduce heat and thermal expansion experienced by the shafts 52 and 54 during operation.

FIG. 4 shows a support assembly 56 according to an alternative embodiment of the present disclosure. As shown in FIG. 4, the support assembly 56 can include a plurality of flat, plate-like supports or members 62 having a generally triangular shape or construction that are arranged in a spaced apart series about the shaft 54 (and/or 52) and connected to the shafts 54 (and/or 52) and the downstream 32B (and/or upstream 32A) ends of the retort body 32, e.g., by welding, fusing, etc.

In addition, as generally shown in FIG. 2A, the support system 50 further can include bearing assemblies 70 that rotatably support the shafts 52 and 54 along the furnace housing 20. The bearing assemblies 70 can include bearings 72 connected to the shafts 52 and 54, such that the shafts are rotatable. The bearings 72 can include high temperature bearings, such as bearings rated for temperatures up to 662° F. or more. The bearings 72 are connected to and support a second end portion or area 52B and 54B of the shafts 52 and 54. The bearing assemblies 70 further include one or more beams or supports 74 that connect and support the bearings 72 along the furnace housing 20. The supports 74 can be connected to one or more sections 24 of the furnace housing 20. The shafts 52 and 54 and/or bearings 74 can be cooled, e.g., by one or more water or air cooling systems. FIG. 2A further shows that the shafts 52 and 54 can extend through openings or passages 76 defined through sections 24 of the furnace housing 20. The openings 76 can be sealed, e.g., with sealing materials, sealing members, etc., to help to reduce heat loss from the furnace housing 20.

The system 10 further includes one or more retort drive systems or mechanisms operatively connected to one or both of the opposing shafts 52/54 to drive movement of the retort 30. The system 10 also can include one or more control systems including at least one controller, CPU, processor, etc. in communication with retort drive system(s) and operable to transmit one or more control signals to the retort driving system(s) to control driving, e.g., activating, varying the speed, stopping reversing, etc., of the drive system.

According to embodiments of the present disclosure, the control system can control the drive system to oscillate the retort back and forth during heating of the metallic articles e.g., in opposite, first and second directions or in a side to side motion. In one embodiment, the drive system can oscillate the retort 30 up to about 360° back and forth. In another embodiment, the drive system can oscillate the retort 30 up to about 180° back and forth, and in yet another embodiment, the drive system can continuously oscillate the retort 30 up to about 90° back and forth. The drive system can be controlled to drive the retort at substantially constant speeds or at varying speeds. In some embodiments, the drive system can oscillate the retort at varying amounts, e.g., combinations or cycles of oscillations of up to 360°, up to 180°, up to, 90° in one or more directions. Oscillating of the retort can improve the processing (to achieve better temperature uniformity and longer dwell times with a shorter retort) of metallic articles in comparison to continuous full rotation of the retort; however, the control system further can be configured to rotate the retort body multiple revolutions without departing from the scope of the present disclosure.

FIGS. 1, 2A-2B, 3A, 3B, and 3D further show that the retort furnace 12 includes a discharge assembly 80 that is in communication with the discharge outlet 40 of retort body 32, and the quenching tank 14 that receives metallic articles discharged from the discharge outlet 40. In particular, the discharge assembly 80 includes a discharge chute 82 that extends from the furnace housing 20 into the quenching tank 12. The discharge chute 82 is periodically brought into communication with the discharge outlet 40 with oscillation or rotation of the retort 30 for discharging of metallic articles from the retort 30.

In one embodiment, the discharge outlet 40 can include a plurality of discharge slots or elongated openings 84 defined through the circumferential sidewall 34 of the retort body 32, though a single discharge slot or opening can be employed without departing from the scope of the present disclosure. As the discharge slots 84 are periodically brought into at least partial alignment with the discharge chute 82 (e.g., an inlet or opening of the discharge chute), metallic articles pass through the aligned discharge slot 84 and into the discharge chute 84 to be directed to the quenching tank 14. Furthermore, the discharge chute 82 can be substantially sealed against the outer circumferential surface 34B of the retort body 32, e.g., via a sealing material or sealing members, to help to reduce dissipation of heat from the retort furnace 12 during operation.

In addition, as shown in FIGS. 2B, 3A, 3B, and 3D, the retort furnace 12 includes an inlet assembly 90 in communication with the charge inlet 38 of the retort body 32 for loading of metallic articles into the retort body 32. In particular, the inlet assembly 90 can include a fixed inlet or charging chute 92 positioned along a top portion or section 24A of the furnace body 20. The fixed inlet chute 92 is configured to vertically release metallic articles into the chamber 36 of the retort body 32.

In one embodiment, as shown in FIGS. 3A-5B, the charge inlet 38 includes an inlet slot or elongated opening 94 defined through the circumferential sidewall 34 of the retort body 32; however, the charge inlet 38 can include a plurality of slots or openings without departing from the scope of the present disclosure. The inlet slot 94 is periodically brought into communication with the fixed inlet chute 92 with the oscillation or rotation of the retort 30 for loading of a series or charges of metallic articles into the retort chamber 36. In this regard, as the retort 30 is oscillated or rotated, the inlet slot 94 is periodically, at least partially, aligned with the fixed inlet chute 92 (e.g., an outlet of the fixed inlet chute 92) such that metallic articles pass from the fixed inlet chute 92 through the inlet slot 94 and into the chamber 36 of the retort body 32. Periodic communication between the inlet slot 94 and the fixed inlet chute 92, as well as between the discharge slot 84 and discharge chute 82 can facilitate a substantially constant flow of metallic articles through the retort body 32 to help to provide for repeatable and reliable heating of metallic articles (especially in comparison to traditional retort furnaces).

Furthermore, the fixed inlet chute 92 can be substantially sealed against the outer circumferential surface 34B of the retort body 32, e.g., by a sealing material or one or more sealing members, to help to reduce dissipation of heat from the retort furnace 12. The fixed inlet chute 92 also allows for preheating of the metallic articles in the inlet chute, e.g., due to exhaust 96 from the retort body when the inlet chute 92 and inlet slot 94 are at least partially aligned. In some embodiments, a refractory ring 98 optionally can be included to set up a preheat chamber.

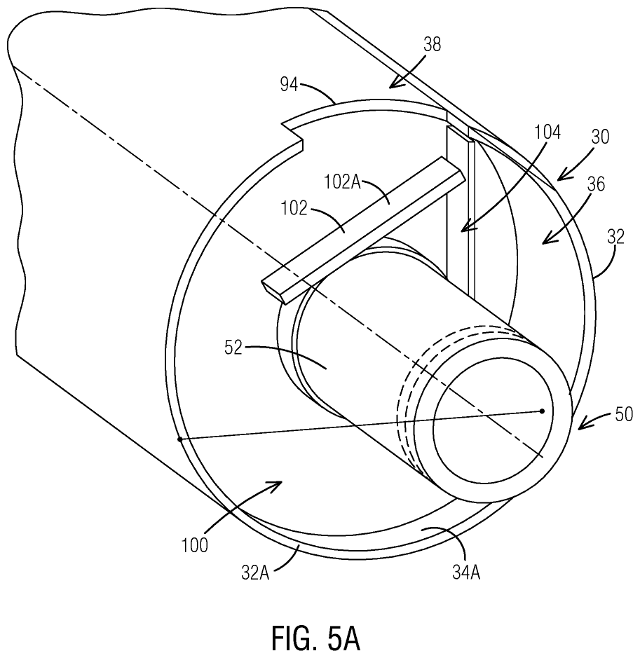

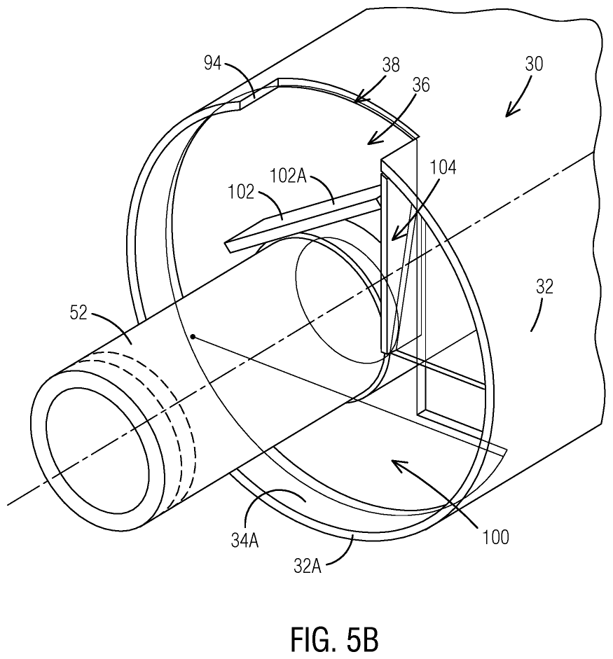

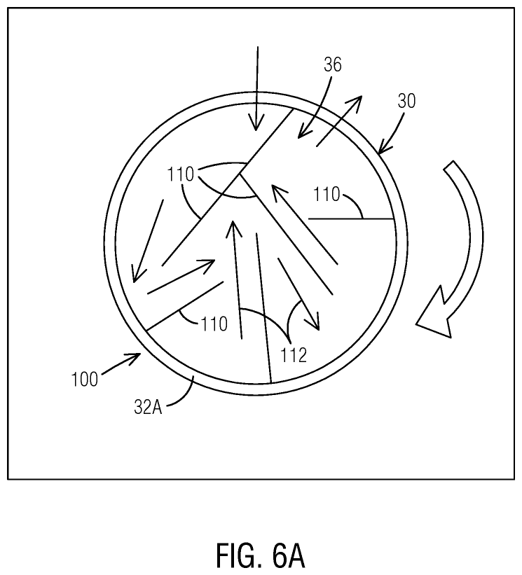

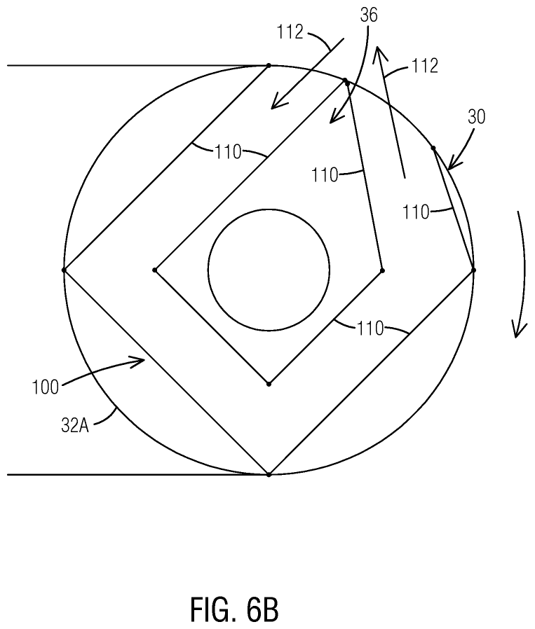

FIGS. 5A-5B and 6A-6B further show that the retort can include an inlet section or area 100 at or substantially adjacent the upstream end 32A of the retort body 32. The inlet section or area 100 can be configured to direct or funnel metallic articles received into the chamber 36 of the retort body 32 through the charge inlet to the inner surface 34A of the circumferential sidewall 34 of the retort body 32 in a cascading manner, such that metallic articles do not free fall from the charge inlet 38 in the retort body 32 and crash into the opposing side of the retort body 32. In this regard, the inlet section or area 100 can help to reduce, inhibit, or prevent damage to, e.g., scoring, nicking, scratching, etc., metallic articles received into the chamber 36 of the retort body 32.

In one embodiment, the inlet section 100 can include one or more support bars or engagement members 102 positioned within the chamber 36 of the retort body 32 to engage and direct metallic articles receive in the retort body 32 from the inlet slot 94. In particular, the support bar(s) 102 can be connect to and oscillate or rotate with the retort body 32 to cascade the metallic articles toward a circumferential side portion of the interior surface 34A of the circumferential sidewall 34 of the retort 30 as the retort 30 moves to prevent dropping of metallic articles directly into the retort 30, i.e., dropping directly from the inlet slot 94 and straight down onto the opposing interior surface 34A of the circumferential sidewall 34. The support bar(s) 102 can be in at least partial alignment with the inlet slot 94 to engage metallic articles received into the chamber 36 of the retort body 32 through the inlet slot 94. The support bar(s) 102 further can be sloped or angled in relation to the inlet slot 94 to help to direct metallic articles to the interior surface 34A of the circumferential sidewall 34, without jamming or other substantial disruptions of the flow of metallic articles through the inlet slot 94.

As shown in FIGS. 5A and 5B, the inlet section 100 can include one or more support members 104 that support the support bar(s) 102. In particular, a portion of the support bar(s) 102 can be connected to the support member 104, e.g., via welding, fusing, etc., and a portion of the support bar(s) 102 can be connected to the shaft 52 of the support system 50, e.g., via welding, fusing, etc. The support bar(s) 102 further can have a plate-like shape with a generally flat upper surface 102A that engages and directs metallic articles; however, the support bar(s) 102 can include alternative configurations, e.g., with curved or arcuate surfaces, without departing from the scope of the present disclosure. The support bar(s) 102 can be formed from one or more metallic materials, though other synthetic, composite, etc. materials can be used without departing from the scope of the present disclosure.

In alternative embodiments, as shown in FIGS. 6A and 6B, the inlet section or area 100 of the retort 30 can include a plurality of support bars or engagement members 110 configured to engage and direct metallic articles received into the retort body 32 through the charge inlet 38 in a cascading manner to help to reduce, prevent, or inhibit damage to the metallic articles as the metallic articles are received into the retort body 32. In this regard, the plurality of engagement members 110 can define a path or passage 112, e.g., serpentine and/or an approximately 360° path, through which the metallic articles move and are directed to surface 34A as the retort 30 is oscillated or rotated.

According to one embodiment of the present disclosure, the system 10 further can be configured to run a cleaning cycle for removal of lodged or stuck metallic articles or debris from the chamber 36 of the retort body 32. During the cleaning cycle, cleaning materials, including but not limited to hard spherical cleaning objects, can be received in the retort body 32, e.g., through the inlet slot 94, and the retort 30 can be rotated or oscillated for a predetermined time interval. The cleaning materials can be moved and directed by the helical flights 42 from the upstream end 32A of the retort body 32 to the downstream end 32B of the retort body 32 and can engage lodged metallic articles or debris to clean the chamber 36 of the retort body 32. The cleaning materials can be discharged from the discharge slot 84 of the retort body 32.

According to a method or process for processing metallic articles, and during operation of the system 10, metallic articles can be loaded or otherwise received within an inlet chute 92 of a retort furnace 12. One or more heaters can be activated (e.g., via a control system) to heat a furnace chamber 22 of the retort furnace 12 to a prescribed temperature, e.g., to about 1000° F., to about 1600° F., to about 2100° F. or more, for carburizing or annealing or other heat treatment of the metallic articles.

A retort 30 of the retort furnace 12 further can be oscillated back and forth, e.g., up to about 90°, up to about 180°, up to about 360°, etc. back and forth, and periodically the inlet chute 92 is brought into at least partially alignment with a charge inlet slot 94 defined through a circumferential surface 34 of the retort 30, with oscillation of the retort 30, and metallic articles can be received from the inlet chute 92 into a chamber 36 of the retort 30.

The metallic articles can be received into an inlet section 100 of the retort 30 including one or more support bars 102 or 110 that are configured to engage and direct metallic articles into the chamber 36 of the retort 30 in a cascading manner to an interior surface 34A of the retort 30, e.g., to reduce, inhibit, or prevent damage to the metallic articles loaded into the retort 30.

Furthermore, metallic articles received within the retort 30 can be engaged by helical flights 42 positioned in the chamber 36 of the retort 30 (e.g., upon exiting of the inlet section 100) and moved toward a discharge end 32 of the retort 30. In particular, due to oscillation of the retort 30, metallic articles can be engaged by various sections, e.g., 44A, of the helical flights 42 and moved along the retort 30 to the discharge end 32B of the retort 30.

When metallic articles reach the discharge end 32B of the retort 30, metallic articles can be discharged from the retort 30 through a discharge outlet slot 84 defined through the circumferential surface 34 of the retort 30. For example, metallic articles can be discharged periodically from the discharge outlet slot 84 each time the discharge outlet slot 84 is at least partially aligned with a discharge chute 82, during oscillation (or rotation) of the retort 30.

The metallic articles can be directed through the discharge chute 82 to one or more quenching tanks 14 including a liquid or gas for cooling metallic articles. After quenching of metallic articles, metallic articles can be moved from the quenching tank 14 to one or more additional processing stations 16 for additional or post processing of annealed, carburized, etc. metallic articles, e.g., processing stations for cutting, stamping, etc. of metallic articles.

The method further can include a cleaning cycle for the retort. For example, one or more cleaning materials, e.g., spherical object, can be added to the retort chamber 36 and the retort 30 can be oscillated or rotated, e.g., at constant or variable speeds, such that the cleaning materials move through the retort 30 to dislodge any metallic articles or debris lodged or stuck in the chamber 36 of the retort 30.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

What is claimed is:

1. A system for treatment of metallic articles, comprising:
a retort furnace comprising:
a furnace housing having a furnace chamber defined therein;
at least one heat source in communication with the furnace chamber;
a retort received within and extending along the furnace chamber, the retort including a retort body defining a retort chamber, and having a charge inlet through which the metallic articles are introduced into the retort chamber, a discharge outlet for discharge of the metallic articles from the retort chamber, and a plurality of flights mounted to the retort body in spaced series along the retort chamber;
a drive system connected to the retort body, the drive system configured to cause rotation or oscillation of the retort body or a combination thereof; and
a control system including a controller configured to transmit control signals to the drive system for controlling the rotation or oscillation of the retort body in first and second directions up to 360° in one or both directions, including starting the rotation or oscillation, stopping the rotation or oscillation, varying speed of the rotation or oscillation, reversing the rotation or oscillation, or combinations thereof, in conjunction with controlling the at least one heat source for heating of the metallic articles within the retort chamber to a desired temperature and to control dwell times and facilitate substantial temperature uniformity of the metallic articles as the metallic articles move along the flights toward the discharge outlet.

2. The system of claim 1, further comprising a support system for moveably coupling the retort to the furnace housing, the support system in communication with the retort drive system.

3. The system of claim 2, wherein the support system comprises a pair of shafts connected to opposite ends of the retort body and at least partially extending along the retort chamber; and bearing assemblies rotatably supporting each of the shafts; wherein the drive system is operatively connected to at least one of the shafts so as to drive rotation or oscillation of the shafts and cause rotation or oscillation of the retort body.

4. The system of claim 3, wherein the shafts of the support system comprise a diameter of approximately 12 inches to approximately 24 inches.

5. The system of claim 3, further comprising a gas system coupled to the shafts of the support system and configured to supply a gas to the shafts of the support system; and wherein the shafts of the support system further comprise openings through which the gas supplied by the gas system is introduced into the retort chamber.

6. The system of claim 1, wherein the retort body comprises a length of approximately 100 inches to approximately 500 inches.

7. The system of claim 1, wherein the charge inlet of the retort body comprises at least one inlet opening defined along a side wall of the retort body and through which the metallic articles are introduced into the retort chamber; and at least one engagement member arranged below the at least one inlet opening in a position to direct the metallic articles received through at least one inlet opening of the charge inlet in a cascading motion toward an interior surface of the side wall of the retort body.

8. The system of claim 7, wherein the at least one engagement member comprises a plurality of engagement members arranged to define a substantially serpentine path from the at least one inlet opening toward the flights within the retort chamber.

9. The system of claim 7, further comprising an inlet assembly in communication with the charge inlet of the retort body, wherein the inlet assembly includes a charging chute positioned along a top portion of the retort and configured to vertically release the metallic articles into the charge inlet of the retort body from the top portion of the retort.

10. The system of claim 1, wherein the flights comprise a series of helical flights arranged along the retort chamber so as to be engaged by the metallic articles, wherein at the retort body is rotated or oscillated, the metallic articles are moved along the retort chamber toward the discharge by engagement of the flights with the metallic articles.

11. A method of treating metallic articles, comprising:
loading a plurality of metallic articles into a retort chamber of a retort through an inlet chute;
supplying heat to a furnace chamber in which the retort is positioned to heat the furnace chamber to a temperature sufficient for carburizing or annealing of the metallic articles;
oscillating or rotating the retort back and forth so as to cause the metallic articles to be engaged by a series of flights located along the retort chamber and be moved along the retort chamber toward a discharge;
controlling the oscillation of the retort so as to control a dwell time during which the metallic articles are heated within the retort chamber to facilitate a uniformity of heating of the metallic articles; and
discharging the metallic articles from the retort chamber.

12. The method of claim 11, wherein loading the metallic articles into the retort chamber comprises feeding the metallic articles in a substantially vertical direction from top portion of the furnace chamber; and directing the metallic articles toward an interior surface of the retort chamber.

13. The method of claim 11, wherein controlling the oscillation or rotation of the retort comprises moving the retort in an at least partially rotating motion up to 360° in each of a first direction and a second direction, the second direction being opposite the first direction.

14. The method of claim 13, wherein as the retort is oscillated, a charge inlet of the retort is periodically aligned with the inlet chute sufficient to enable a next plurality of the metallic articles to pass from the inlet chute through the charge inlet and into the retort chamber.

15. The method of claim 11, wherein discharging the metallic articles comprises discharging a portion of the metallic articles from a discharge outlet of the retort to a discharge chute when the discharge outlet is at least partially aligned with the discharge chute during oscillation of the retort.

16. The method of claim 11, wherein discharging the metallic articles comprises directing the metallic articles along a discharge chute and to at least one quenching tank.

17. The method of claim 11, wherein loading the metallic articles into the retort chamber comprises periodically feeding the metallic articles through an inlet opening in a circumferential side wall of the retort, and toward the side, wall in a cascading motion.

18. A retort furnace comprising:
a furnace chamber having at least one heat source in communication therewith for heating the furnace chamber;
a retort received within the furnace chamber, the retort including a rotatable retort body defining a retort chamber, and having a charge inlet through which a plurality of metallic articles are introduced into the retort chamber, a discharge outlet for discharge of the metallic articles from the retort chamber, and a plurality of flights mounted in spaced series along the retort chamber;
a support system for rotatably supporting the retort body within the furnace chamber and including at least one shaft coupled to at least one of an upstream or a downstream end of the retort body;
a drive system connected to the support system, the drive system configured to rotate the at least one shaft of the support system to cause rotation or oscillation of the retort body; and
a control system including a controller configured to transmit control signals to the drive system for controlling the rotation or oscillation of the retort body in first and second directions up to 360° in one or both directions, in conjunction with controlling the at least one heat source for heating of the metallic articles within the retort chamber to a desired temperature and to control dwell times and facilitate substantial temperature uniformity of the metallic articles as the metallic articles move along the flights toward the discharge outlet.

19. The retort furnace of claim 18, wherein the at least one shaft of the support system comprises a pair of shafts connected to opposite ends of the retort body with bearing assemblies rotatably supporting each shaft; and further comprising a gas system coupled to the shafts and configured to supply a gas thereto; wherein the shafts of the support system further comprise openings through which the gas supplied by the gas system is introduced into the retort chamber.

20. The retort furnace of claim 18, wherein the charge inlet comprises at least one inlet opening defined along a side wall of the retort body and through which the metallic articles are introduced vertically into the retort chamber; and at least one engagement member arranged below the at least one inlet opening in a position to direct the metallic articles in a cascading motion toward a circumferential portion of an interior surface of the side wall of the retort body.
